(19) United States
(12) Patent Application Publication
(10) Pub. No.: US 2024/0225805 A1
(43) Pub. Date: Jul. 11, 2024

(54) Electrified Toothbrushing Device

(71) Applicant: Danny Santana, Albuquerque, NM (US)

(72) Inventor: Danny Santana, Albuquerque, NM (US)

(21) Appl. No.: 18/095,833

(22) Filed: Jan. 11, 2023

(51) Int. Cl. A61C 17/34

(52) U.S. Cl. CPC A61C 17/3418

(57) ABSTRACT

An electrified toothbrushing device for reducing gingival recession includes an electric toothbrush, which in turn comprises an elongate housing in which a motor and a battery are attached and positioned. A drive shaft of the motor extends through a first end of the elongate housing. A brush head is selectively attachable to the first end of the elongate housing so that the brush head is operationally engaged to the drive shaft. A plurality of bristles of the brush head is rotatable about an axis that is defined by the drive shaft. The battery is operationally engaged to the motor so that the battery is positioned to selectively power the motor. The elongate housing can be grasped in a hand of a user to selectively position the plurality of bristles along sets of upper and bottom teeth to clean the teeth.

### CROSS-REFERENCE TO RELATED APPLICATIONS

Not Applicable

### STATEMENT REGARDING FEDERALLY SPONSORED RESEARCH OR DEVELOPMENT

Not Applicable

### The Names of the Parties to a Joint Research Agreement

Not Applicable

### Incorporation-by-Reference of Material Submitted on a Compact Disc or as a Text File Via the Office Electronic Filing System

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toothbrushes and more particularly pertains to a new toothbrush for reducing gingival recession. The present invention discloses a toothbrush having bristles attached to a rotating shaft extending linearly from an elongate housing, wherein the bristles are rotated in one direction for cleaning upper teeth and in the other direction for cleaning lower teeth.

### (2) Description of Related Art Including Information Disclosed Under 37 CFR 1.97 and 1.98

The prior art relates to toothbrushes, which may comprise toothbrushes with bristles that oscillate or rotate, but wherein oscillation or rotation is about an axis perpendicular to the toothbrush and to the teeth. What is lacking in the prior art is a toothbrush having bristles attached to a shaft extending linearly from an elongate housing, wherein the bristles are rotated in one direction about the shaft for cleaning upper teeth and in the other direction for cleaning lower teeth.

### BRIEF SUMMARY OF THE INVENTION

An embodiment of the disclosure meets the needs presented above by generally comprising an electric toothbrush, which in turn comprises an elongate housing that defines an interior space. A motor and a battery are attached to the elongate housing and are positioned in the interior space. A drive shaft of the motor extends through a first end of the elongate housing. A brush head is selectively attachable to the first end of the elongate housing so that the brush head is operationally engaged to the drive shaft. A plurality of bristles of the brush head is rotatable about an axis that is defined by the drive shaft. The battery is operationally engaged to the motor so that the battery is positioned to selectively power the motor. The elongate housing is configured to be grasped in a hand of a user, enabling the user to selectively position the plurality of bristles along sets of upper and bottom teeth. The plurality of bristles thus is configured to clean the teeth.

Another embodiment of the disclosure includes an electrified toothbrushing system, which comprises an electric toothbrush, as per the disclosure above, wherein the brush head is one of a plurality of brush heads. The electrified toothbrushing system also comprises a charging device, a charging cord, and a plurality of posts attached to a base of the charging device to provide for upright storage of the brush heads.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of an electrified toothbrushing device according to an embodiment of the disclosure.

FIG. 2 is a bottom view of an embodiment of the disclosure.

FIG. 3 is a side view of an embodiment of the disclosure.

FIG. 4 is a side view of an embodiment of the disclosure.

FIG. 5 is a cross-sectional view of an embodiment of the disclosure.

FIG. 6 is an exploded view of an embodiment of the disclosure.

FIG. 7 is a detail view of an embodiment of the disclosure.

FIG. 8 is a detail view of an embodiment of the disclosure.

FIG. 9 is a side view of an embodiment of the disclosure.

FIG. 10 is an end view of an embodiment of the disclosure.

FIG. 11 is a top view of an embodiment of the disclosure.

FIG. 12 is a top view of an embodiment of the disclosure.

FIG. 13 is an isometric perspective view of an embodiment of the disclosure.

FIG. 14 is an in-use view of an embodiment of the disclosure.

FIG. 15 is an in-use view of an embodiment of the disclosure.

### DETAILED DESCRIPTION OF THE INVENTION

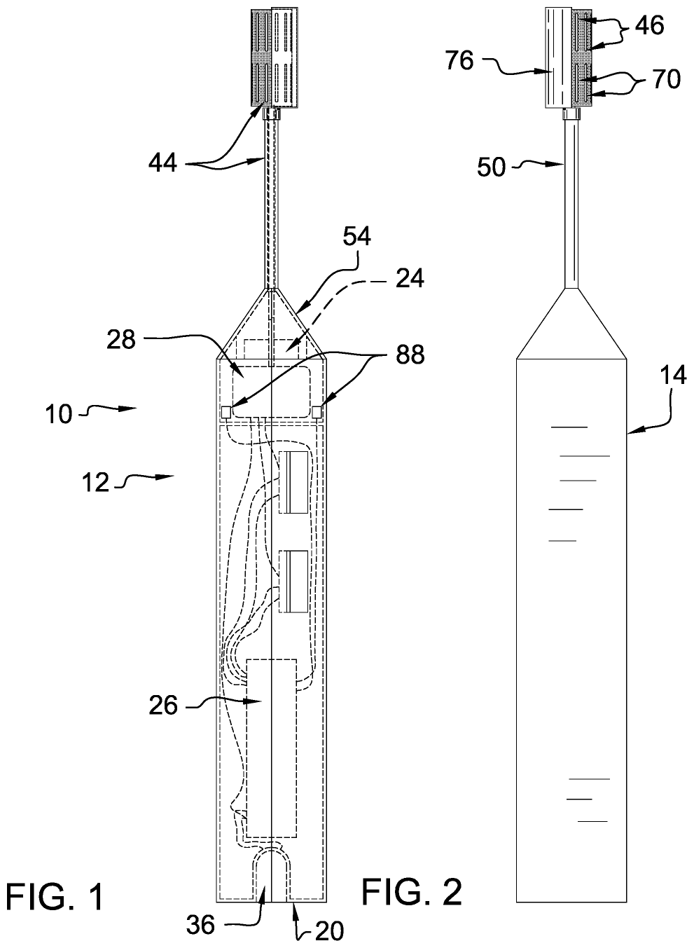

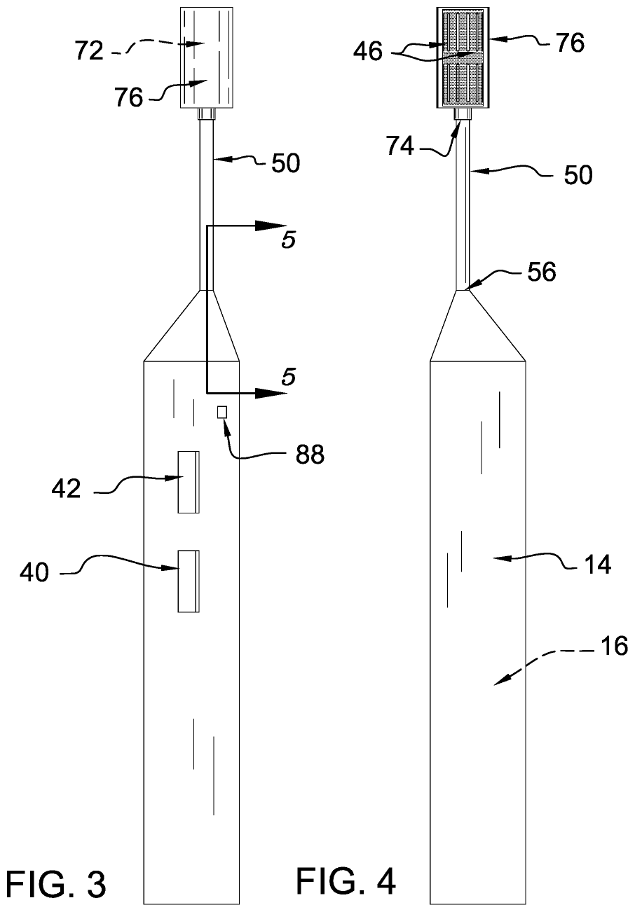

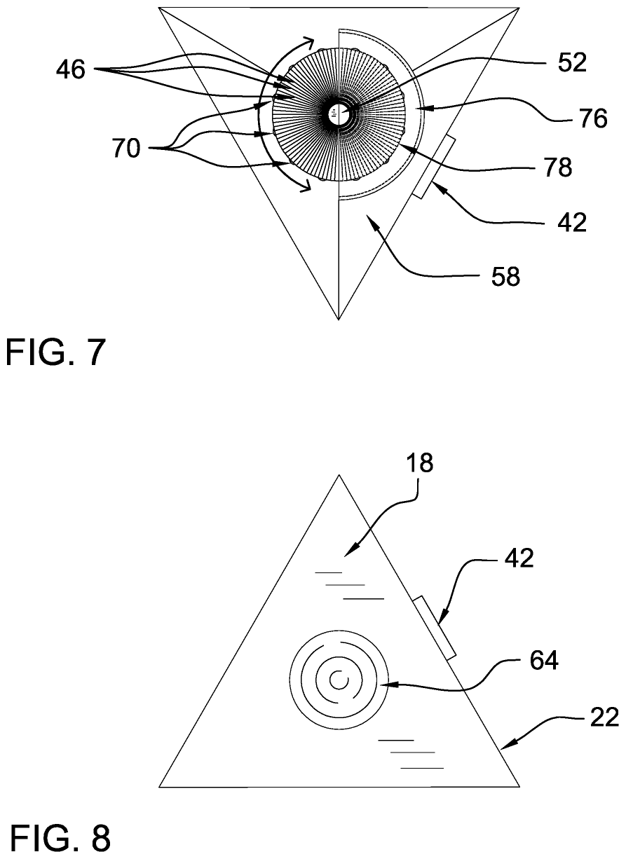

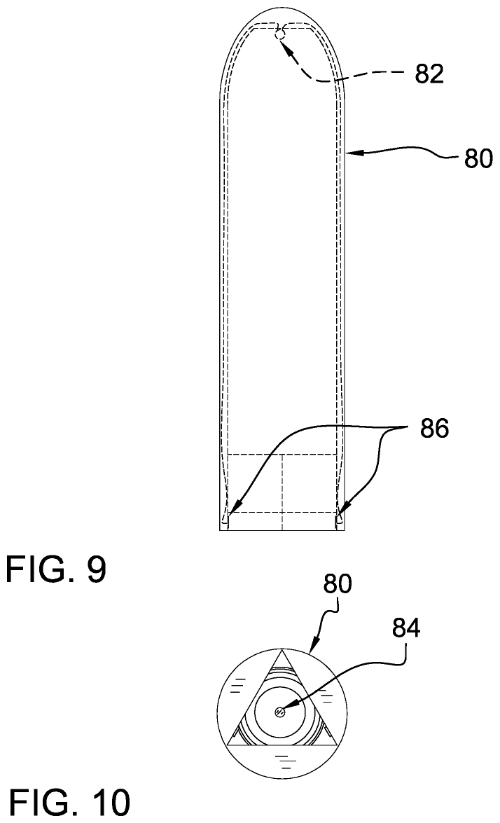

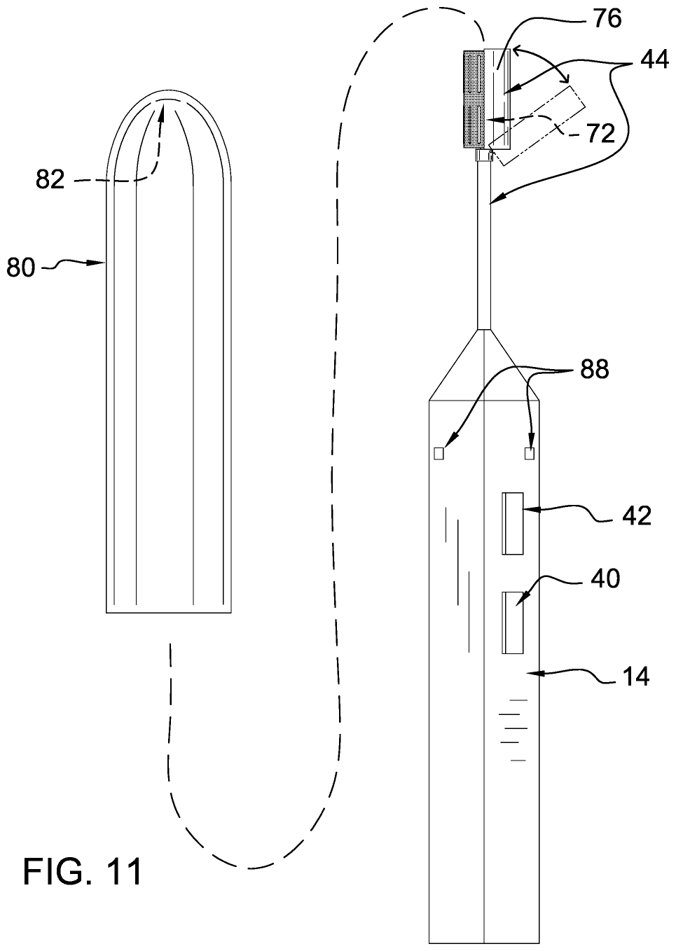

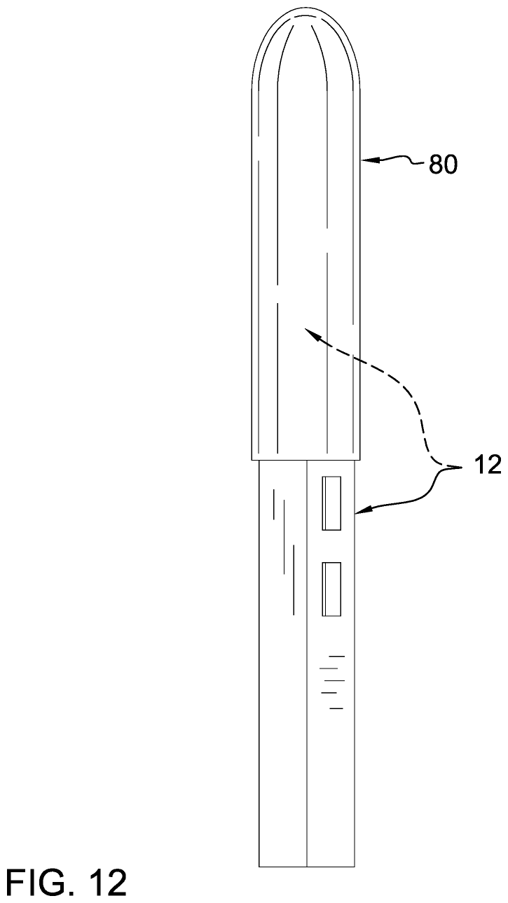

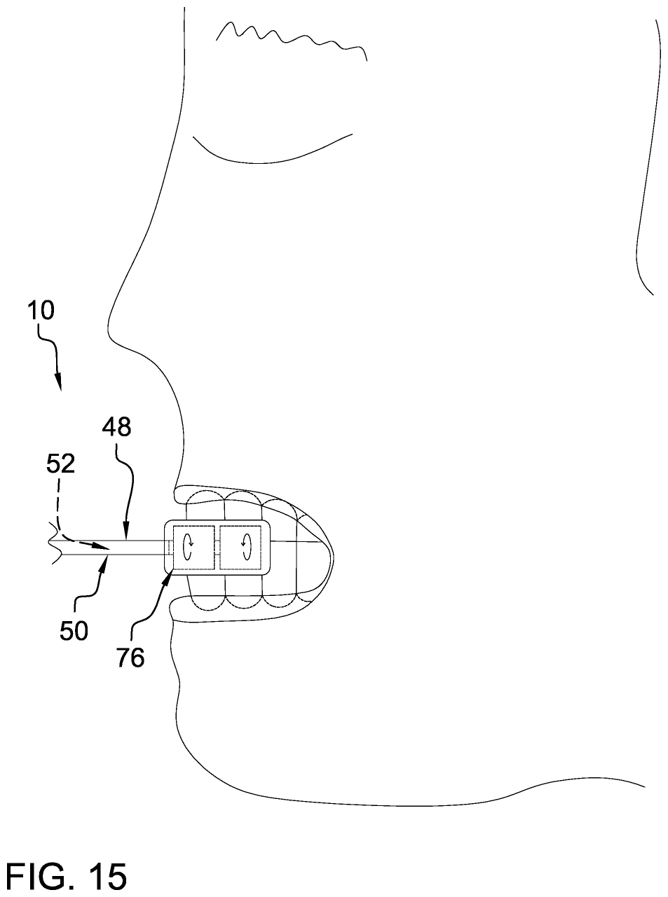

With reference now to the drawings, and in particular to FIGS. 1 through 15 thereof, a new toothbrush embodying the principles and concepts of an embodiment of the disclosure and generally designated by the reference numeral 10 will be described.

As best illustrated in FIGS. 1 through 15, the electrified toothbrushing device 10 generally comprises an electric toothbrush 12, which in turn comprises an elongate housing 14 that defines an interior space 16. The elongate housing 14 is tapered adjacent to its first end 18 so that the first end 18 is substantially circumferentially smaller than its second end 20. The elongate housing 14 has a cross-sectional profile 22, which may be substantially triangularly shaped, as shown in FIG. 8, circular, ovoid, square, or the like. A first connector 24 is attached to the first end 18 of the elongate housing 14.

A battery 26, which is rechargeable, and a motor 28 are attached to the elongate housing 14 and are positioned in the interior space 16. The battery 26 is operationally engaged to the motor 28 so that the battery 26 is positioned to selectively power the motor 28. A drive shaft 30 of the motor 28 extends through the first end 18 of the elongate housing 14. A first mating surface 32 is positioned in an operating end 34 of the drive shaft 30.

A charging port 36 is attached to the second end 20 of the elongate housing 14 and is configured to selectively couple to a charging device 38 to charge the battery 26. A power switch 40 is attached to the elongate housing 14 and is operationally engaged to the battery 26 and to the motor 28. The power switch 40 is configured to be selectively switched to operationally engage the motor 28 to the battery 26. A selector switch 42 is attached to the elongate housing 14 and is operationally attached to the motor 28. The selector switch 42 is configured to be selectively switched to control a direction of rotation of the drive shaft 30.

A brush head 44 is selectively attachable to the first end 18 of the elongate housing 14 so that the brush head 44 is operationally engaged to the drive shaft 30. A plurality of bristles 46 of the brush head 44 is rotatable about an axis 48 that is defined by the drive shaft 30. The elongate housing 14 is configured to be grasped in a hand of a user, enabling the user to selectively position the plurality of bristles 46 along sets of upper and bottom teeth. The plurality of bristles 46 thus is configured to clean the teeth.

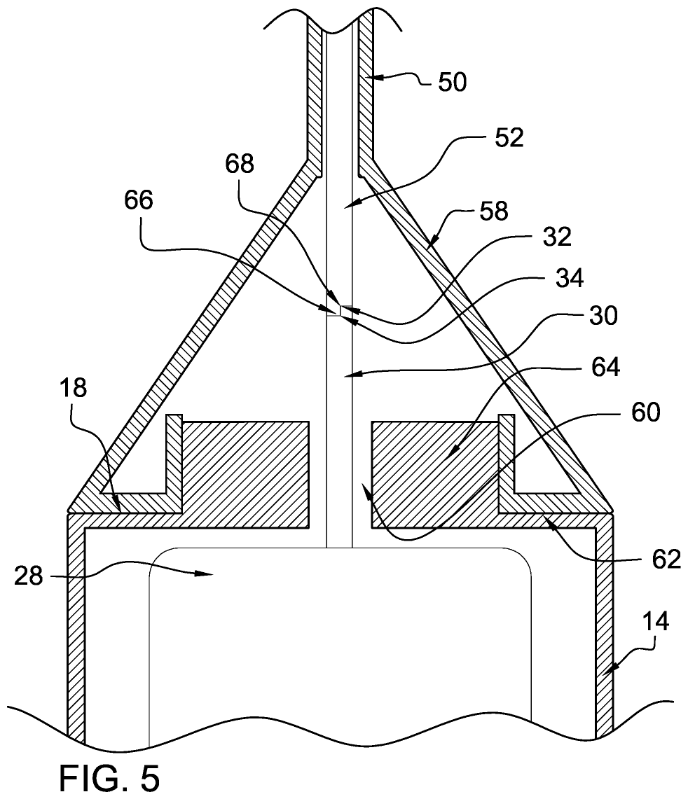

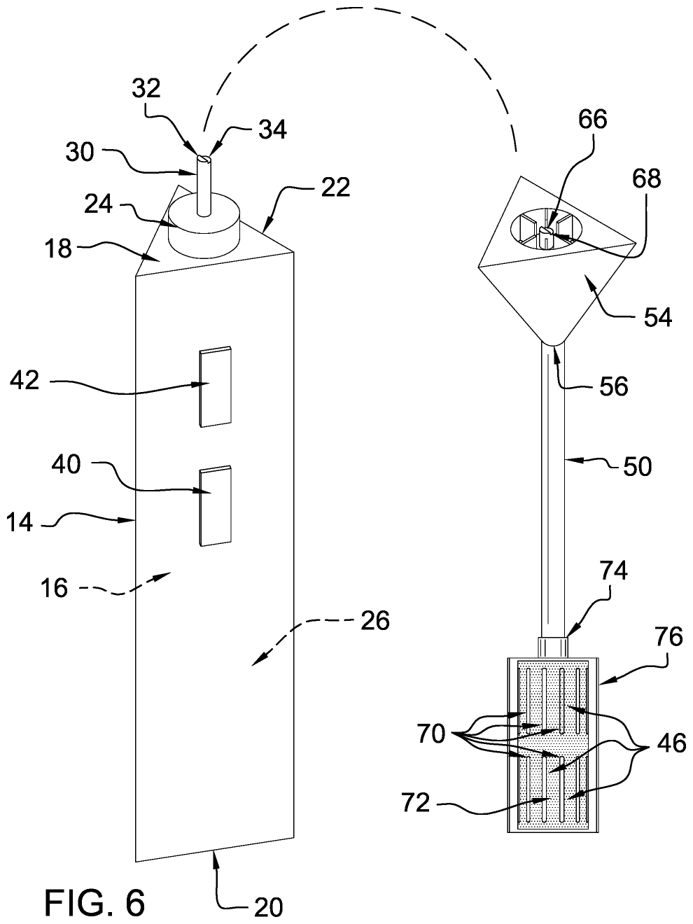

The brush head 44 comprises a pipe 50, which is selectively attachable to the first end 18 of the elongate housing 14 so that the pipe 50 extends substantially linearly from the elongate housing 14. A transfer shaft 52 is rotationally attached to and is positioned in the pipe 50. A second connector 54, which is complementary to the first connector 24, is attached to a first terminus 56 of the pipe 50. The second connector 54 is enabled to selectively engage the first connector 24 to removably attach the pipe 50 to the elongate housing 14 and to operationally engage the transfer shaft 52 to the drive shaft 30. As shown in FIGS. 5 and 6, the second connector 54 comprises a shell 58, which has a cutout 60 positioned in its lower facet 62. The first connector 24 comprises a ring 64, which is complementary to and selectively insertable into the cutout 60 to removably attach the brush head 44 to the elongate housing 14.

The pipe 50 and the transfer shaft 52 are resiliently bendable. The transfer shaft 52 is selectively operationally engageable to the drive shaft 30 so that the transfer shaft 52 extends substantially linearly from the drive shaft 30. A second mating surface 66, which is complementary to the first mating surface 32, is positioned in a receiving end 68 of the transfer shaft 52 so that the drive shaft 30 operationally engages the transfer shaft 52 as the brush head 44 is attached to the elongate housing 14, as shown in FIG. 5.

The plurality of bristles 46 and a plurality of tabs 70 are attached to and extend from a section 72 of the transfer shaft 52 that protrudes from a second terminus 74 of the pipe 50, with the tabs 70 being interspersed amongst the bristles 46. The bristles 46 and the tabs 70 comprise silicone, rubber, or elastomer and are resiliently flexible.

A plate 76 is hingedly attached to the second terminus 74 of the pipe 50. The plate 76 is arcuate and extends from the pipe 50 along an outer limit 78 of the plurality of bristles 46. The plate 76 thus is configured to shield a cheek of the user from the plurality of bristles 46 as the bristles 46 rotate.

The electrified toothbrushing device 10 also comprises a cap 80, which is selectively positionable over the brush head 44 and which is attachable to the elongate housing 14. A bulb 82, which is attached to and positioned within the cap 80 and which may comprise a light emitting diode 84, is configured to emit ultraviolet light to disinfect the brush head 44. A pair of first contacts 86 is attached to the cap 80 and is operationally engaged to the bulb 82. A pair of second contacts 88 is attached to the elongate housing 14 and is operationally engaged to the battery 26. Each second contact 88 conductively engages a respective first contact 86 to operationally engage the bulb 82 to the battery 26.

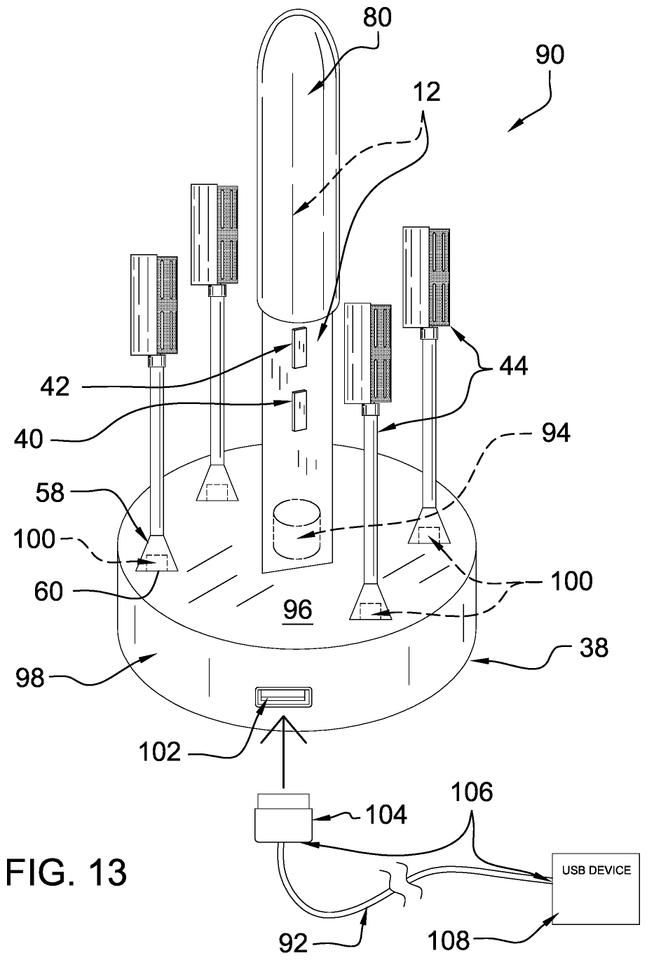

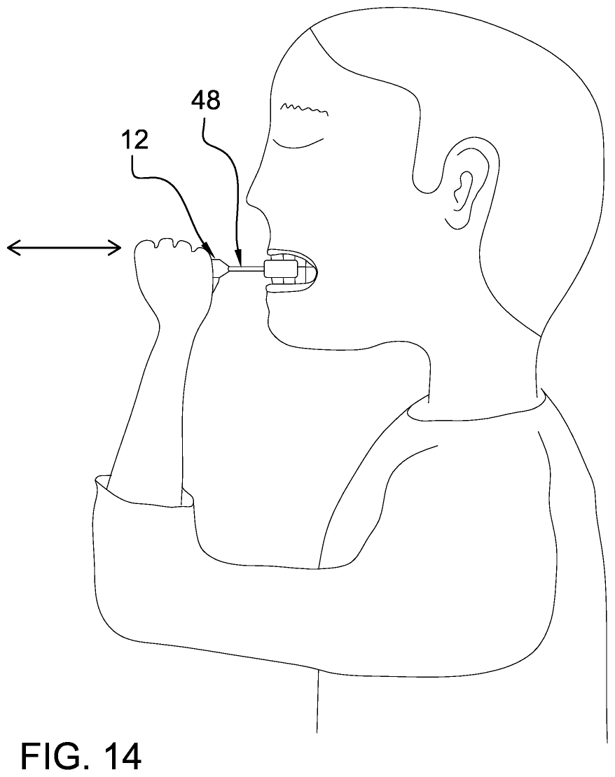

The present invention also anticipates an electrified toothbrushing system 90, as shown in FIG. 13, which comprises an electric toothbrush 12 and a cap 80, as per the specification above. In the electrified toothbrushing system 90, the brush head 44 is one of a plurality of brush heads 44. The brush heads 44 may be of different sizes for users of different sizes, and the bristles 46 of the brush heads 44 may be soft, stiff, or the like.

The electrified toothbrushing system 90 also comprises a charging device 38 and a charging cord 92. The charging device 38 comprises a charging plug 94, which is attached to and which extends substantially axially from an upper face 96 of a base 98. The charging plug 94 is complementary to the charging port 36 so that the charging plug 94 is selectively insertable into the charging port 36 to charge the battery 26. The battery 26 may be charged inductively.

A plurality of posts 100 is attached to and extends substantially perpendicularly from the upper face 96 of the base 98. Each post 100 is complementary to the cutout 60 in the shell 58 of a respective brush head 44 so that the post 100 is selectively insertable into the cutout 60 to removably attach the respective brush head 44 to the base 98.

A charger port 102 attached to the base 98. The charging cord 92 has a charger plug 104 attached to one opposed end 106 and an electrical plug 108 attached to the other opposed end 106. The charger plug 104 is complementary to the charger port 102 so that the charger plug 104 is selectively insertable into the charger port 102 to operationally engage the battery 26 to a source of electrical current to charge the battery 26.

In use, the elongate housing 14 is grasped in a hand of a user and the power switch 40 is switched. The bristles 46 then are positioned, alternately and horizontally, along sets of upper and bottom teeth. The selector switch 42 is used to control a direction of rotation of the drive shaft 30, and thus the bristles 46. In a first direction of rotation, the bristles 46 are positioned against and clean the upper teeth. In a second direction of rotation, the bristles 46 are positioned against and clean the lower teeth.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electrified toothbrushing device comprising an electric toothbrush, the electric toothbrush comprising:
an elongate housing defining an interior space;
a motor attached to the elongate housing and positioned in the interior space, a drive shaft of the motor extending through a first end of the elongate housing;
a brush head selectively attachable to the first end of the elongate housing, such that the brush head is operationally engaged to the drive shaft, such that a plurality of bristles of the brush head is rotatable about an axis defined by the drive shaft; and
a battery attached to the elongate housing and positioned in the interior space, the battery being operationally engaged to the motor, such that the battery is positioned for selectively powering the motor, wherein the elongate housing is configured for grasping in a hand of a user, enabling the user for selectively positioning the plurality of bristles along sets of upper and bottom teeth, wherein the plurality of bristles is configured for cleaning the teeth.

2. The electrified toothbrushing device of claim 1, further including:
a first connector attached to the first end of the elongate housing; and
the brush head comprising:
a pipe selectively attachable to the first end of the elongate housing, such that the pipe extends substantially linearly from the elongate housing,
a transfer shaft rotationally attached to and positioned in the pipe, the transfer shaft being selectively operationally engageable to the drive shaft, such that the transfer shaft extends substantially linearly from the drive shaft,
a second connector attached to a first terminus of the pipe, the second connector being complementary to the first connector, such that the second connector is enabled for selectively engaging the first connector for removably attaching the pipe to the elongate housing and operationally engaging the transfer shaft to the drive shaft,
the plurality of bristles being attached to and extending from a section of the transfer shaft protruding from a second terminus of the pipe, and
a plate hingedly attached to the second terminus of the pipe, the plate being arcuate and extending from the pipe along an outer limit of the plurality of bristles, wherein the plate is configured for shielding a cheek of the user from the plurality of bristles.

3. The electrified toothbrushing device of claim 2, further including:
a first mating surface positioned in an operating end of the drive shaft; and
a second mating surface positioned in a receiving end of the transfer shaft, the second mating surface being complementary to the first mating surface, such that the drive shaft operationally engages the transfer shaft as the brush head is attached to the elongate housing.

4. The electrified toothbrushing device of claim 2, wherein the pipe and the transfer shaft are resiliently bendable.

5. The electrified toothbrushing device of claim 2, wherein:
the second connector comprises a shell having a cutout positioned in a lower facet of the shell; and
the first connector comprises a ring, the ring being complementary to the cutout, such that the ring is selectively insertable into the cutout for removably attaching the brush head to the elongate housing.

6. The electrified toothbrushing device of claim 2, wherein the bristles of the plurality of bristles comprise silicone, rubber, or elastomer.

7. The electrified toothbrushing device of claim 2, further including a plurality of tabs attached to and extending from the section of the transfer shaft protruding from the second terminus of the pipe, such that the tabs of the plurality of tabs are interspersed amongst the bristles of the plurality of bristles, the tabs of the plurality of tabs being resiliently flexible.

8. The electrified toothbrushing device of claim 7, wherein the tabs of the plurality of tabs comprise silicone, rubber, or elastomer.

9. The electrified toothbrushing device of claim 1, further including:
the battery being rechargeable; and
a charging port attached to a second end of the elongate housing, wherein the charging port is configured for selectively coupling to a charging device for charging the battery.

10. The electrified toothbrushing device of claim 1, further including:
a power switch attached to the elongate housing and being operationally engaged to the battery and the motor, wherein the power switch is configured for being selectively switched for operationally engaging the motor to the battery; and
a selector switch attached to the elongate housing and being operationally engaged to the motor, wherein the selector switch is configured for being selectively switched for controlling a direction of rotation of the drive shaft.

11. The electrified toothbrushing device of claim 1, further including:
a cap selectively positionable over the brush head and attachable to the elongate housing;
a bulb attached to and positioned within the cap, the bulb being configured for emitting ultraviolet light for disinfecting the brush head;
a pair of first contacts attached to the cap and operationally engaged to the bulb; and
a pair of second contacts attached to the elongate housing and operationally engaged to the battery, such that each second contact of the pair of second contacts conductively engages a respective first contact of the pair of first contacts for operationally engaging the bulb to the battery.

12. The electrified toothbrushing device of claim 1, wherein the elongate housing is tapered adjacent to the first end, such that the first end is substantially circumferentially smaller than a second end of the elongate housing.

13. The electrified toothbrushing device of claim 1, wherein the elongate housing has a cross-sectional profile, the cross-sectional profile being substantially triangularly shaped.

14. An electrified toothbrushing device comprising an electric toothbrush, the electric toothbrush comprising:
an elongate housing defining an interior space, the elongate housing being tapered adjacent to a first end of the elongate housing, such that the first end is substantially circumferentially smaller than a second end of the elongate housing, the elongate housing has a cross-sectional profile, the cross-sectional profile being substantially triangularly shaped;
a first connector attached to the first end of the elongate housing;
a motor attached to the elongate housing and positioned in the interior space, a drive shaft of the motor extending through a first end of the elongate housing;
a first mating surface positioned in an operating end of the drive shaft;
a brush head selectively attachable to the first end of the elongate housing, such that the brush head is operationally engaged to the drive shaft, such that a plurality of bristles of the brush head is rotatable about an axis defined by the drive shaft, the brush head comprising:
a pipe selectively attachable to the first end of the elongate housing, such that the pipe extends substantially linearly from the elongate housing,
a transfer shaft rotationally attached to and positioned in the pipe, the transfer shaft being selectively operationally engageable to the drive shaft, such that the transfer shaft extends substantially linearly from the drive shaft, the pipe and the transfer shaft being resiliently bendable,
a second mating surface positioned in a receiving end of the transfer shaft, the second mating surface being complementary to the first mating surface, such that the drive shaft operationally engages the transfer shaft as the brush head is attached to the elongate housing,
a second connector attached to a first terminus of the pipe, the second connector being complementary to the first connector, such that the second connector is enabled for selectively engaging the first connector for removably attaching the pipe to the elongate housing and operationally engaging the transfer shaft to the drive shaft, the second connector comprising a shell having a cutout positioned in a lower facet of the shell, the first connector comprising a ring, the ring being complementary to the cutout, such that the ring is selectively insertable into the cutout for removably attaching the brush head to the elongate housing,
the plurality of bristles being attached to and extending from a section of the transfer shaft protruding from a second terminus of the pipe, the bristles of the plurality of bristles comprising silicone, rubber, or elastomer,
a plate hingedly attached to the second terminus of the pipe, the plate being arcuate and extending from the pipe along an outer limit of the plurality of bristles, wherein the plate is configured for shielding a cheek of the user from the plurality of bristles, and
a plurality of tabs attached to and extending from the section of the transfer shaft protruding from a second terminus of the pipe, such that the tabs of the plurality of tabs are interspersed amongst the bristles of the plurality of bristles, the tabs of the plurality of tabs being resiliently flexible, the tabs of the plurality of tabs comprising silicone, rubber, or elastomer;
a battery attached to the elongate housing and positioned in the interior space, the battery being rechargeable, the battery being operationally engaged to the motor, such that the battery is positioned for selectively powering the motor, wherein the elongate housing is configured for grasping in a hand of a user, enabling the user for selectively positioning the plurality of bristles along sets of upper and bottom teeth, wherein the plurality of bristles is configured for cleaning the teeth;
a charging port attached to a second end of the elongate housing, wherein the charging port is configured for selectively coupling to a charging device for charging the battery;
a power switch attached to the elongate housing and being operationally engaged to the battery and the motor, wherein the power switch is configured for being selectively switched for operationally engaging the motor to the battery;
a selector switch attached to the elongate housing and being operationally engaged to the motor, wherein the selector switch is configured for being selectively switched for controlling a direction of rotation of the drive shaft;
a cap selectively positionable over the brush head and attachable to the elongate housing;
a bulb attached to and positioned within the cap, the bulb being configured for emitting ultraviolet light for disinfecting the brush head;
a pair of first contacts attached to the cap and operationally engaged to the bulb; and
a pair of second contacts attached to the elongate housing and operationally engaged to the battery, such that each second contact of the pair of second contacts conductively engages a respective first contact of the pair of first contacts for operationally engaging the bulb to the battery.

15. An electrified toothbrushing system comprising:
an electric toothbrush comprising:
an elongate housing defining an interior space,
a first connector attached to the first end of the elongate housing, a motor attached to the elongate housing and positioned in the interior space, a drive shaft of the motor extending through a first end of the elongate housing,
a brush head selectively attachable to the first end of the elongate housing, such that the brush head is operationally engaged to the drive shaft, such that a plurality of bristles of the brush head is rotatable about an axis defined by the drive shaft, the brush head comprising:
a pipe selectively attachable to the first end of the elongate housing, such that the pipe extends substantially linearly from the elongate housing,
a transfer shaft rotationally attached to and positioned in the pipe, the transfer shaft being selectively operationally engageable to the drive shaft, such that the transfer shaft extends substantially linearly from the drive shaft, the pipe and the transfer shaft being resiliently bendable,
a second connector attached to a first terminus of the pipe, the second connector being complementary to the first connector, such that the second connector is enabled for selectively engaging the first connector for removably attaching the pipe to the elongate housing and operationally engaging the transfer shaft to the drive shaft, the second connector comprising a shell having a cutout positioned in a lower facet of the shell, the first connector comprising a ring, the ring being complementary to the cutout, such that the ring is selectively insertable into the cutout for removably attaching the brush head to the elongate housing,
a battery attached to the elongate housing and positioned in the interior space, the battery being rechargeable, the battery being operationally engaged to the motor, such that the battery is positioned for selectively powering the motor, wherein the elongate housing is configured for grasping in a hand of a user, enabling the user for selectively positioning the plurality of bristles along sets of upper and bottom teeth, wherein the plurality of bristles is configured for cleaning the teeth, and
a charging port attached to a second end of the elongate housing, wherein the charging port is configured for selectively coupling to a charging device for charging the battery;
a cap selectively positionable over the brush head and attachable to the elongate housing;
a bulb attached to and positioned within the cap, the bulb being configured for emitting ultraviolet light for disinfecting the brush head;
a pair of first contacts attached to the cap and operationally engaged to the bulb;
a pair of second contacts attached to the elongate housing and operationally engaged to the battery, such that each second contact of the pair of second contacts conductively engages a respective first contact of the pair of first contacts for operationally engaging the bulb to the battery;
the brush head being one of a plurality of brush heads; and
a charging device comprising:
a base,
a charging plug attached to and extending substantially axially from an upper face of the base, the charging plug being complementary to the charging port, such that the charging plug is selectively insertable into the charging port,
a plurality of posts attached to and extending substantially perpendicularly from the upper face of the base, each post of the plurality of posts being complementary to the cutout in the shell of a respective brush head of a plurality of brush heads, such that the post is selectively insertable into the cutout for removably attaching the respective brush head to the base,
a charger port attached to the base, and
a charging cord having a charger plug attached to one opposed end and an electrical plug attached to the other opposed end, the charger plug being complementary to the charger port, such that the charger plug is selectively insertable into the charger port for operationally engaging the battery to a source of electrical current for charging the battery.
